(19) United States
(12) Patent Application Publication
(10) Pub. No.: US 2026/0354464 A1
(43) Pub. Date: Nov. 12, 2026

(54) HEATING ASSEMBLY AND AEROSOL GENERATING APPARATUS

(71) Applicant: SHENZHEN FIRST UNION TECHNOLOGY CO., LTD., Shenzhen, Guangdong (CN)

(72) Inventors: Zhiming LU, Shenzhen, Guangdong (CN); Ruilong HU, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 19/114,218

(22) PCT Filed: Sep. 4, 2023
(86) PCT No.: PCT/CN2023/116811

§ 371 Date: Mar. 21, 2025

(30) Foreign Application Priority Data
Sep. 22, 2022 (CN) 202211160685.7

(51) Int. Cl. A24F 40/46; A24F 40/53; A24F 40/57; H05B 3/06

(52) U.S. Cl. CPC A24F 40/46; A24F 40/53; A24F 40/57; H05B 3/06

(57) ABSTRACT

A heating assembly and an aerosol generating apparatus are provided. The heating assembly includes: a base; electric heating film layers, which are arranged on a surface of the base and include a first electric heating film layer and a second electric heating film layer that are distributed in a circumferential direction of the base; and a conductive element for feeding electric power to the first electric heating film layer and the second electric heating film layer, where resistance of the first electric heating film layer is different from resistance of the second electric heating film layer, or heating power of the first electric heating film layer is different from heating power of the second electric heating film layer.

### CROSS-REFERENCE TO RELATED APPLICATIONS

This application claims priority to Chinese Patent Application No. 202211160685.7, filed with the China National Intellectual Property Administration on Sep. 22, 2022 and entitled “HEATING ASSEMBLY AND AEROSOL GENERATING APPARATUS”, which is incorporated herein by reference in its entirety.

### TECHNICAL FIELD

This application relates to the field of electronic atomization technologies, and in particular, to a heating assembly and an aerosol generating apparatus.

### BACKGROUND

During use of smoking articles such as cigarettes and cigars, tobacco is burnt to produce smoke. Attempts have been made to provide substitutes for these tobacco-burning articles by producing products that release compounds without burning. An example of such products is a so-called heat-not-burn product, which releases compounds by heating tobacco instead of burning the tobacco.

An existing aerosol generating apparatus has the problems of long preheating time for an aerosol-forming substrate and low user experience.

### SUMMARY

This application provides a heating assembly and an aerosol generating apparatus, aiming at solving the problems of long preheating time and low user experience that exist in an existing aerosol generating apparatus.

An aspect of this application provides a heating assembly, including:
a base;
electric heating film layers, which are arranged on a surface of the base and include a first electric heating film layer and a second electric heating film layer that are distributed in a circumferential direction of the base; and
a conductive element for feeding electric power to the first electric heating film layer and the second electric heating film layer,
where resistance of the first electric heating film layer is different from resistance of the second electric heating film layer, or heating power of the first electric heating film layer is different from heating power of the second electric heating film layer.

Another aspect of this application provides a heating assembly, including:
a base;
electric heating film layers, which are arranged on a surface of the base and include a first electric heating film layer and a second electric heating film layer that are distributed in a circumferential direction of the base; and
a conductive element for feeding electric power to the first electric heating film layer and the second electric heating film layer,
where an axial extension length of the first electric heating film layer is the same as an axial extension length of the second electric heating film layer, while a circumferential extension length of the first electric heating film layer is different from a circumferential extension length of the second electric heating film layer.

Another aspect of this application further provides an aerosol generating apparatus, including:
a base;
electric heating film layers, which are arranged on a surface of the base and include a first electric heating film layer and a second electric heating film layer that are distributed in a circumferential direction of the base; and
a conductive element for feeding electric power to the first electric heating film layer and the second electric heating film layer,
where a heating speed of the second electric heating film layer is greater than a heating speed of the first electric heating film layer.

Another aspect of this application further provides an aerosol generating apparatus, including:
a base;
electric heating film layers, which are arranged on a surface of the base and include a first electric heating film layer and a second electric heating film layer that are distributed in a circumferential direction of the base; and
a conductive element for feeding electric power to the first electric heating film layer and the second electric heating film layer, where the conductive element includes a first electrode and a second electrode, such that a current is capable of flowing from the first electrode to the second electrode through the first electric heating film layer in a first circumferential direction of the base, and flowing from the first electrode to the second electrode through the second electric heating film layer in a second circumferential direction opposite to the first circumferential direction,
where a flow distance of the current in the first circumferential direction is different from a flow distance thereof in the second circumferential direction, or a first circumferential distance is provided between the first electrode and the second electrode in the first circumferential direction, a second circumferential distance is provided between the first electrode and the second electrode in the second circumferential direction, and the first circumferential distance is different from the second circumferential distance.

Another aspect of this application further provides an aerosol generating apparatus, including:
a housing assembly;
a heating assembly, which is arranged in the housing assembly;
a battery cell for providing electric power; and
a circuit configured to obtain temperature information of a second electric heating film layer, and control the battery cell to provide the electric power to a first electric heating film layer and the second electric heating film layer based on the temperature information of the second electric heating film layer.

In the heating assembly and the aerosol generating apparatus according to this application, the electric heating film layers are different in resistance or heating power, so that a temperature of a part of the electric heating film layers can rapidly rise relative to a temperature of another part of the electric heating film layers, so that part of an aerosol-forming substrate can rapidly reach a preheating temperature, a preheating time for the aerosol-forming substrate is shortened, and a vaping waiting time is reduced, thereby improving user experience.

### BRIEF DESCRIPTION OF THE DRAWINGS

One or more embodiments are exemplarily described by corresponding accompanying drawings. These exemplary descriptions do not constitute a limitation on the embodiments, and elements with the same reference numerical signs in the accompanying drawings represent similar elements. Unless otherwise specified, the accompanying drawings do not constitute a limitation on scale.

FIG. 1 is a schematic diagram of an aerosol generating apparatus according to an implementation of this application;

FIG. 2 is a schematic exploded view of an aerosol generating apparatus according to an implementation of this application;

FIG. 3 is a schematic diagram of a heating assembly according to an implementation of this application;

FIG. 4 is a schematic exploded view of a heating assembly according to an implementation of this application;

FIG. 5 is a schematic diagram of a heater in a heating assembly according to an implementation of this application;

FIG. 6 is a schematic top view of a heater according to an implementation of this application;

FIG. 7 is a schematic diagram of another heating assembly according to an implementation of this application;

FIG. 8 is a schematic exploded view of another heating assembly according to an implementation of this application;

FIG. 9 is a schematic diagram of a heater in another heating assembly according to an implementation of this application;

FIG. 10 is a schematic diagram of an electrode connection member in another heating assembly according to an implementation of this application;

FIG. 11 is a schematic top view of another heater according to an implementation of this application; and

FIG. 12 is a schematic diagram of another heater according to an implementation of this application.

### DETAILED DESCRIPTION

To facilitate the understanding of this application, this application is described in more detail below with reference to accompanying drawings and specific implementations. It should be noted that, when an element is described as being “fixed” to another element, the element may be directly on the another element, or one or more intermediate elements may exist therebetween. When an element is described as being “connected” to another element, the element may be directly connected to the another element, or one or more intermediate elements may exist therebetween. The terms “upper”, “lower”, “left”, “right”, “inner”, “outer”, and similar expressions used in this specification are only for the purpose of illustration.

Unless otherwise defined, all technical and scientific terms used in this specification have the same meanings as those commonly understood by a person skilled in the art to which this application belongs. The terms used in the specification of this application are merely for the purpose of describing specific implementations, but are not intended to limit this application. The term “and/or” used in this specification includes any and all combinations of one or more related listed items.

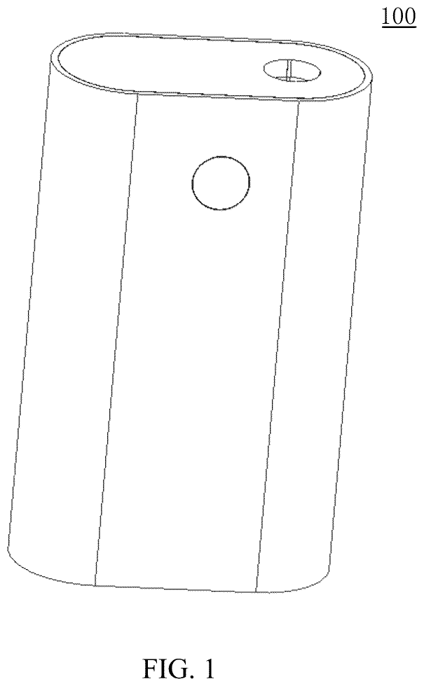

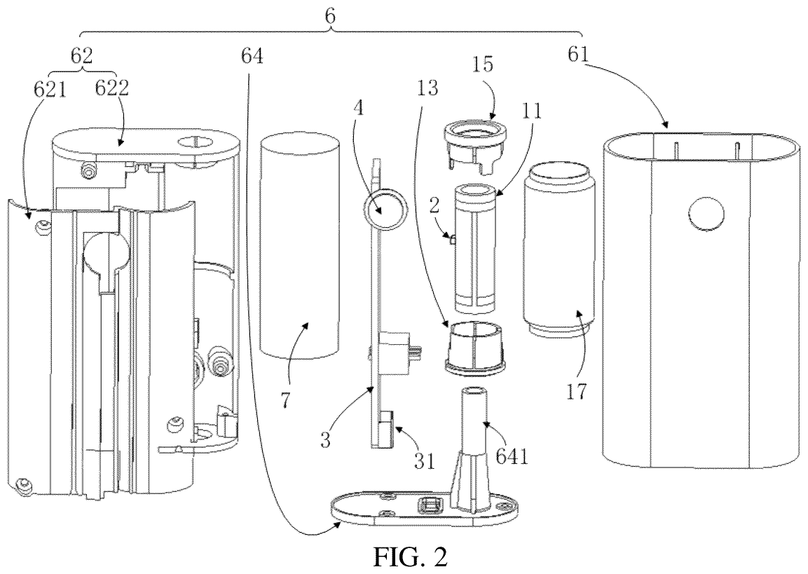

FIG. 1 and FIG. 2 each show an aerosol generating apparatus 100 according to an implementation of this application, which includes a housing assembly 6 and a heater. The heater is arranged in the housing assembly 6.

The housing assembly 6 includes a housing 61, a fixed housing 62, bases, and a bottom cap 64. The fixed housing 62 and the bases are fixed in the housing 61. Each base is used for fixing a base 111, and the base is arranged in the fixed housing 62. The bottom cap 64 is arranged at an end of the housing 61 and covers the housing 61.

Specifically, the bases includes a base 15 that is sleeved at a proximal end of the base 111 and a base 13 that is sleeved at a distal end of the base 111. The base 15 and the base 13 are both arranged inside the fixed housing 62. An air inlet tube 641 protrudes from the bottom cap 64, and an end of the base 13 facing away from the base 15 is connected to the air inlet tube 641. The base 15, the base 111, the base 13, and the air inlet tube 641 are coaxially arranged, and the base 111 is sealed to the base 15 and the base 13 by seal members. The base 13 is also sealed to the air inlet tube 641. The air inlet tube 641 communicates with the outside air to facilitate smooth air intake when a user vapes.

The aerosol generating apparatus 100 further includes a circuit 3 and a battery cell 7. The fixed housing 62 includes a front housing 621 and a rear housing 622. The front housing 621 is fixedly connected to the rear housing 622. The circuit 3 and the battery cell 7 are both arranged in the fixed housing 62, and the battery cell 7 is electrically connected to the circuit 3. A button 4 protrudes from the housing 61. An electric heating film layer on a surface of the base 111, such as a resistance heating film layer and an infrared electric heating coating, can be powered on or off by pressing the button 4. A charging interface 31 is further connected to the circuit 3, and the charging interface 31 is exposed on the bottom cap 64. The user may charge or upgrade the aerosol generating apparatus 100 through the charging interface 31 to ensure continuous use of the aerosol generating apparatus 100.

The aerosol generating apparatus 100 further includes a heat insulation tube 17, and the heat insulation tube 17 is arranged in the fixed housing 62. The heat insulation tube 17 is arranged on a periphery of the base 111. The heat insulation tube 17 can prevent a large amount of heat from being transferred to the housing 61, which otherwise causes the user to feel hot. The heat insulation tube includes a heat insulation material, and the heat insulation material may be heat insulation glue, an aerogel, aerogel felt, asbestos, aluminum silicate, calcium silicate, diatomaceous earth, zirconia, or the like. The heat insulation tube 17 may alternatively be a vacuum heat insulation tube. An infrared reflective coating may be further formed in the heat insulation tube 17 to reflect infrared rays emitted by the infrared electric heating coating on the base 111 back to the base 111, thereby improving heating efficiency.

The aerosol generating apparatus 100 further includes a temperature sensor 2, such as an NTC thermistor, a PTC thermistor or a thermocouple, for detecting a real-time temperature of the base 111 and transmitting the detected real-time temperature to the circuit 3, such that the circuit 3 adjusts a magnitude of a current flowing through the infrared electric heating coating based on the real-time temperature.

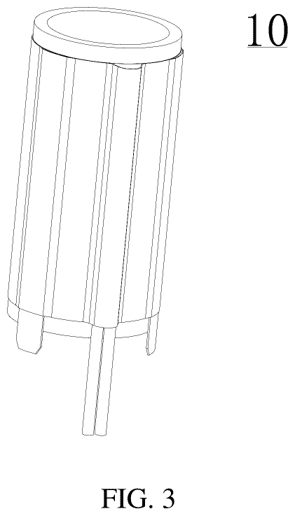

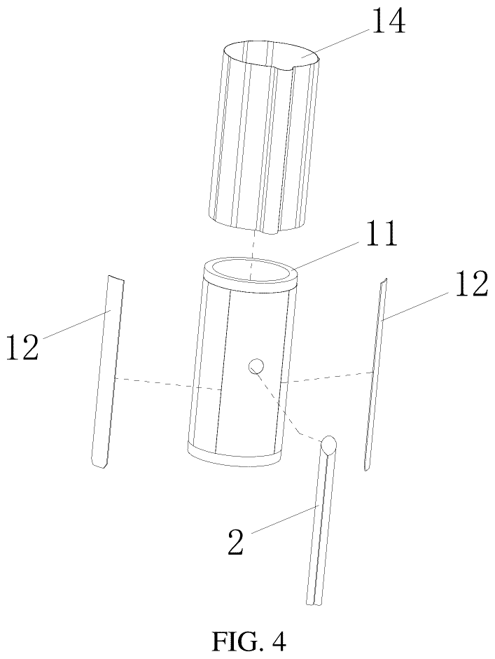

FIG. 3 to FIG. 6 each show a heating assembly according to an implementation of this application. The heating assembly 10 includes a heater 11, an electrode connection member 12, a temperature sensor 2, and a holding member 14. The heater 11 includes:
a base 111 in which a chamber suitable for containing an aerosol-forming substrate is formed.

Specifically, the base 111 includes a proximal end and a distal end, and a surface extending between the proximal end and the distal end. The base 111 is hollow to form a chamber suitable for containing an aerosol-forming product. The base 111 may be tubular, such as cylindrical, prismatic, or in another cylindrical shape. The base 111 is preferably cylindrical, and the chamber is a cylindrical hole that runs through a middle portion of the base 111. An inner diameter of the hole is slightly greater than an outer diameter of the aerosol-forming product, making it convenient to place the aerosol-forming product in the chamber for heating. The base 111 has an inner diameter ranging from 6 mm to 15 mm, or from 7 mm to 15 mm, or from 7 mm to 14 mm, or from 7 mm to 12 mm, or from 7 mm to 10 mm. The base 111 has an axial extension length ranging from 15 mm to 25 mm, or from 16 mm to 25 mm, or from 18 mm to 25 mm, or from 18 mm to 24 mm, or from 18 mm to 22 mm.

The base 111 may be made of a high-temperature resistant and infrared transparent material such as quartz glass, a ceramic or mica, or another material with high infrared transmittance, such as a high-temperature resistant material with infrared transmittance of 95% or above, which is not specifically limited herein.

The aerosol-forming substrate is a substrate that can release a volatile compound that can form an aerosol. The volatile compound may be released by heating the aerosol-forming substrate. The aerosol-forming substrate may be a solid or a liquid, or may include solid and liquid components. The aerosol-forming substrate may be loaded onto a carrier or a support through adsorption, coating, or impregnation, or in another manner. The aerosol-forming substrate may conveniently be a part of an aerosol generating product.

The aerosol-forming substrate may include nicotine. The aerosol-forming substrate may include tobacco, for example, may include a tobacco-containing material including volatile compounds with a tobacco aroma. The volatile compounds with a tobacco aroma are released from the aerosol-forming substrate when the aerosol-forming substrate is heated. Preferably, the aerosol-forming substrate may include a homogeneous tobacco material, such as deciduous tobacco. The aerosol-forming substrate may include at least one aerosol-forming agent. The aerosol-forming agent may be any suitable known compound or a mixture of compounds. During use, the compound or the mixture of compounds facilitates dense and stable aerosol formation, and is substantially resistant to thermal degradation at an operating temperature of an aerosol-generating system. Suitable aerosol-forming agents are well known in this field, including but not limited to: a polyol, such as triethylene glycol, 1,3-butanediol, and glycerol; a polyol ester, such as glycerol monoacetate, glycerol diacetate, or glycerol triacetate; and a fatty acid ester of a monocarboxylic acid, a dicarboxylic acid, or a polycarboxylic acid, such as dimethyl dodecanedioate and dimethyl tetradecanedioate. Preferably, the aerosol-forming agent is polyhydric alcohol or a mixture thereof, such as triethylene glycol, or 1,3-butanediol, and most preferably, glycerol.

An infrared electric heating coating 112 is formed on a surface of the base 111. The infrared electric heating coating 112 may be formed on an outer surface of the base 111 or an inner surface of the base 111.

In this example, the infrared electric heating coating 112 is formed on the outer surface of the base 111. The infrared electric heating coating 112 receives electric power to generate heat, and then generate infrared rays with a certain wavelength, such as far infrared rays with a wavelength ranging from 8 μm to 15 μm. When the wavelength of the infrared rays matches an absorption wavelength of the aerosol-forming substrate, energy of the infrared rays can be easily absorbed by the aerosol-forming substrate.

The infrared electric heating coating 112 is preferably made of far infrared electrothermal ink, ceramic powder and an inorganic binder which are fully and evenly stirred and then coated on the outer surface of the base 111, and then dried and cured for a certain period of time. The infrared electric heating coating 112 has a thickness ranging from 30 μm to 50 μm. Certainly, the infrared electric heating coating 112 may alternatively be made of tin tetrachloride, tin oxide, antimony trichloride, titanium tetrachloride and cupric sulfate anhydrous which are mixed in a certain proportion and then coated on the outer surface of the base 111, or is one of a silicon carbide ceramic layer, a carbon fiber composite layer, a zirconium titanium oxide ceramic layer, a zirconium titanium nitride ceramic layer, a zirconium titanium boride ceramic layer, a zirconium titanium carbide ceramic layer, an iron oxide ceramic layer, an iron nitride ceramic layer, an iron boride ceramic layer, an iron carbide ceramic layer, a rare earth oxide ceramic layer, a rare earth nitride ceramic layer, a rare earth boride ceramic layer, a rare earth carbide ceramic layer, a nickel cobalt oxide ceramic layer, a nickel cobalt nitride ceramic layer, a nickel cobalt boride ceramic layer, a nickel cobalt carbide ceramic layer or a high silicon molecular sieve ceramic layer. The infrared electric heating coating 112 may alternatively be an existing coating made of another material.

A conductive element includes an electrode 113 and an electrode 114 that are spaced apart on the base 111, and is used for feeding electric power provided by the battery cell 7 to the infrared electric heating coating 112.

The electrode 113 and the electrode 114 remain in contact with the infrared electric heating coating 112 to form an electrical connection. The electrode 113 and the electrode 114 may be conductive coatings, and each conductive coating may be a metal coating. The metal coating may include silver, gold, palladium, platinum, copper, nickel, molybdenum, tungsten, niobium or an alloy material thereof.

The electrode 113 and the electrode 114 extend in an axial direction of the base 111 and are elongated. Axial extension lengths of the electrode 113 and the electrode 114 are the same as an axial extension length of the infrared electric heating coating 112. A circumferential extension length or width of each of the electrode 113 and the electrode 114 ranges from 0.2 mm and 5 mm, preferably from 0.2 mm to 4 mm, further preferably from 0.2 mm to 3 mm, further preferably from 0.2 mm to 2 mm, and further preferably from 0.5 mm to 2 mm. In this way, the electrode 113 and the electrode 114 divide the infrared electric heating coating 112 into two infrared electric heating coatings in a circumferential direction of the base 111, namely, a first infrared electric heating coating and a second infrared electric heating coating. The two separated infrared electric heating coatings are distributed in the circumferential direction of the base 111 and connected in parallel between the electrode 113 and the electrode 114. The electrode 113 and the electrode 114 simultaneously feed electric power provided by the battery cell 7 to the first infrared electric heating coating and the second infrared electric heating coating. After the electrode 113 and the electrode 114 conduct electricity, a current may flow from one of the electrodes to the other electrode roughly in a circumferential direction of the base 111 through the first infrared electric heating coating. In addition, the current may also flow from one of the electrodes to the other electrode roughly in another circumferential direction (a direction opposite to the aforementioned circumferential direction.) of the base 111 through the second infrared electric heating coating.

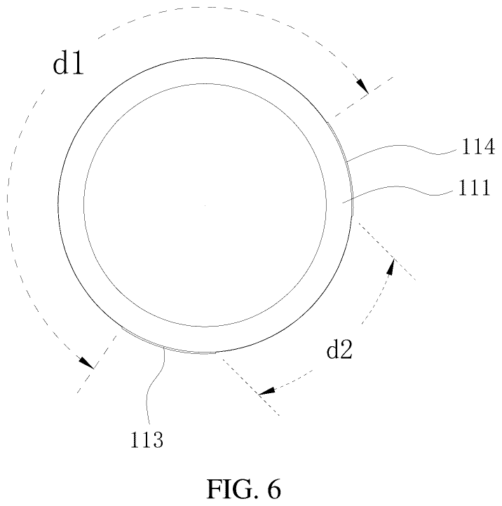

In an example, there is a first circumferential distance d1 between the electrode 113 and the electrode 114 in a first circumferential direction of the base 111, such as a clockwise direction in FIG. 6. In this case, an infrared electric heating coating between the electrode 113 and the electrode 114 is the first infrared electric heating coating. There is a second circumferential distance d2 between the electrode 113 and the electrode 114 in a second circumferential direction opposite to the first circumferential direction, such as a counterclockwise direction in FIG. 6. In this case, an infrared electric heating coating between the electrode 113 and the electrode 114 is the second infrared electric heating coating. The first circumferential distance d1 is different from the second circumferential distance d2. If the first infrared electric heating coating has a circumferential extension length of d1 and the second infrared electric heating coating has a circumferential extension length of d2, while an axial extension length of the first infrared electric heating coating is the same as an axial extension length of the second infrared electric heating coating, a flow distance of the current in the first circumferential direction is also different from a flow distance thereof in the second circumferential direction. If the infrared electric heating coating has a uniform thickness, resistance of the first infrared electric heating coating is greater than resistance of the second infrared electric heating coating, that is, the two adjacent infrared electric heating coatings have different resistance in the circumferential direction of the base 111.

After the electrode 113 and the electrode 114 conduct electricity, heating power of the first infrared electric heating coating is less than heating power of the second infrared electric heating coating, that is, the two adjacent infrared electric heating coatings have different heating power in the circumferential direction of the m base 111. A heating speed of the second infrared electric heating coating is greater than a heating speed of the first infrared electric heating coating. Therefore, compared with that of part of the aerosol-forming substrate corresponding to the first infrared electric heating coating, the temperature of part of the aerosol-forming substrate corresponding to the second infrared electric heating coating can rise rapidly and an aerosol that can be vaped is generated, thereby shortening a preheating time for the aerosol-forming substrate and reducing a vaping waiting time.

It should be noted that, the heating speed of the second infrared electric heating coating is greater than the heating speed of the first infrared electric heating coating, which can be verified in the following manner: The same preset temperature is set, and when the temperature of the second infrared electric heating coating reaches a preset temperature from an initial temperature (such as an ambient temperature), if the temperature of the first infrared electric heating coating is less than the preset temperature, it may indicate that the heating speed of the second infrared electric heating coating is greater than that of the first infrared electric heating coating. The preset temperature may be a maximum temperature of the aerosol generating apparatus 100 or an operating temperature, that is, a temperature at which the aerosol-forming substrate can generate an aerosol.

Due to different heating speeds, there is a large temperature difference between the second infrared electric heating coating and the first infrared electric heating coating in a preheating stage of the aerosol generating apparatus 100. However, there is a small temperature difference between the second infrared electric heating coating and the first infrared electric heating coating in a thermal insulation stage or a vaping stage of the aerosol generating apparatus 100. The above preheating stage, thermal insulation stage or vaping stage are different duration periods in a curve of a temperature change of the aerosol-forming product or infrared electric heating coating with time.

In a preferred implementation, the first circumferential distance d1 is 1.5-6 times, or twice, or 4 times, or a different times as large as the second circumferential distance d2. Taking an example in which the first circumferential distance dl is twice as large as the second circumferential distance d2, the resistance of one of the infrared electric heating coatings is twice that of the other infrared electric heating coating (assuming the infrared electric heating coating has a uniform thickness).

It should be noted that, in the above example, the resistance of the first infrared electric heating coating is greater than the resistance of the second infrared electric heating coating, which is caused by the different circumferential extension lengths of the infrared electric heating coatings. That is, based on a resistance calculation formula R=τL/S, when resistivity τ is constant, if S is constant, larger L indicates larger corresponding resistance (the second infrared electric heating coating has larger L, so the resistance thereof is also larger). In another example, this may be caused by the same circumferential extension length of the infrared electric heating coatings, but different axial extension lengths of the infrared electric heating coatings. That is, when the resistivity τ is constant, if L is also constant, resistance corresponding to smaller S is also larger (S=axial extension length of an infrared electric heating coating*thickness of the infrared electric heating coating). Alternatively, this may be caused by different circumferential extension lengths of the infrared electric heating coatings, and different axial extension lengths of the infrared electric heating coatings.

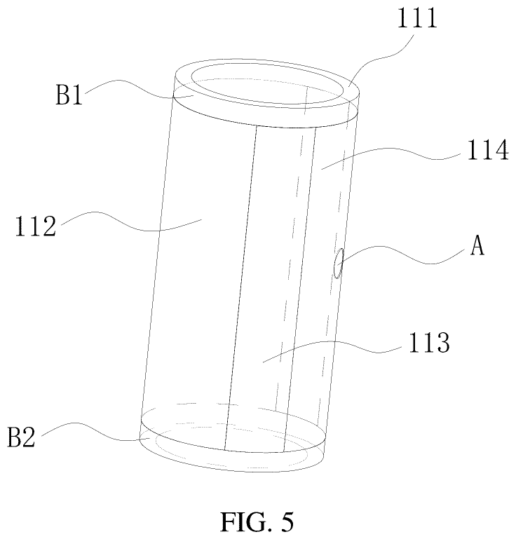

In an example, the infrared electric heating coating 112 and the proximal end or distal end of the base 111 may be spaced apart. For example, in FIG. 5, a portion B1 and a portion B2 on the outer surface of the base 111 are provided with no electrode and no infrared electric heating coating 112; and axial extension lengths of the portion B1 and the portion B2 may be as small as possible. Generally, the axial extension length of each of the portion B1 and the portion B2 ranges from 0 mm to 1 mm, that is, greater than 0 mm and less than or equal to 1 mm, and may be 0.2 mm, 0.4 mm, 0.5 mm, 0.7 mm, or the like in a specific example.

In an example, the infrared electric heating coating 112 and the proximal end or distal end of the base 111 are not spaced apart, that is, it is also feasible that the axial extension length of the electrode or infrared electric heating coating 112 is the same as the axial extension length of the base 111. In this way, on the one hand, a coating area of the infrared electric heating coating 112 can be increased, and on the other hand, a loss of heat can be avoided.

The electrode connection member 12 remains in contact with the conductive element to form an electrical connection. A quantity of electrode connection members 12 is consistent with a quantity of conductive elements, that is, the electrode 113 has a corresponding electrode connection member 12 and the electrode 114 has a corresponding electrode connection member 12. The electrode connection member 12 may be electrically connected to the battery cell 7 through a wire. For example, one end of the wire is welded to the electrode connection member 12, and the other end of the wire is electrically connected to the battery cell 7 (may be electrically connected to the battery cell 7 through a circuit board 3, or may be directly connected to the battery cell 7). The electrode connection member 12 is preferably made of copper, a copper alloy, aluminum or an aluminum alloy material with good conductivity, with a surface plated with silver or gold to reduce contact resistance and improve welding performance of the material surface.

Similar to the conductive element, the electrode connection member 12 extends in the axial direction of the base 111 and is in the shape of a strip. The axial extension length of the electrode connection member 12 and the axial extension length of the conductive element may be the same. The circumferential extension length or width of the electrode connection member 12 ranges from 0.2 mm to 5 mm, preferably from 0.2 mm to 4 mm, further preferably from 0.2 mm to 3 mm, further preferably from 0.2 mm to 2 mm, and further preferably from 0.5 mm to 2 mm. The thickness of the electrode connection member 12 ranges from 0.05 mm to 1 mm, and may be smaller. In a specific example, the thickness of the electrode connection member 12 may be 0.1 mm, 0.2 mm, 0.4 mm, 0.5 mm, or the like. In a preferred implementation, the axial extension length of the electrode connection member 12 is greater than the axial extension length of the conductive element, but less than the sum of the axial extension length of the conductive element and the axial extension length of the portion B2. Alternatively, the axial extension length of the electrode connection member 12 is greater than the sum of the axial extension length of the conductive element and the axial extension length of the portion B2, that is, an upper end of the electrode connection member 12 is flush with an upper end of the infrared electric heating coating 112, and a lower end of the electrode connection member 12 extends out of the distal end of the base 111. This facilitates welding of the wire to the electrode connection member 12. In a further preferred implementation, a distance between the lower end of the electrode connection member 12 and the distal end of the base 111 ranges from 1 mm to 10 mm, preferably from 1 mm to 8 mm, further preferably from 1 mm to 6 mm, and further preferably from 1 mm to 4 mm.

The outer surface of the base 111 has a mark A at a preset position, so that the user can assemble the temperature sensor 2 to the preset position based on the mark A, that is, locate the temperature sensor. The mark A can mark a pigment at the preset position by printing or spraying or in another manner. In a preferred implementation, the mark A is located between the electrode 113 and the electrode 114 in a direction opposite to the first circumferential direction, that is, a region in which the second infrared electric heating coating is located, or a region in which the infrared electric heating coating with smaller resistance or higher heating power is located. Usually, the mark A is provided near a central point. In this way, temperature information of the second infrared electric heating coating can be obtained by the temperature sensor 2, so that the circuit 3 can control the battery cell 7 to provide electric power to the first infrared electric heating coating and the second infrared electric heating coating.

The holding member 14 is used for holding the electrode connection member 12 on the electrode 113 and the electrode 114, and holding the temperature sensor 2 on the mark A. The holding member 14 includes a high-temperature adhesive tape or a heat shrinkable tube. In a practical application, the high-temperature adhesive tape can be directly wound around the electrode connection member 12 and the temperature sensor 2, or the heat shrinkable tube is sleeved outside the electrode connection member 12 and the temperature sensor 2, and then is shrunk by heating up to fasten the electrode connection member 12 and the temperature sensor 2. In a preferred implementation, the electrode connection member 12 is partially exposed outside the holding member 14. This facilitates welding of the wire to the electrode connection member 12.

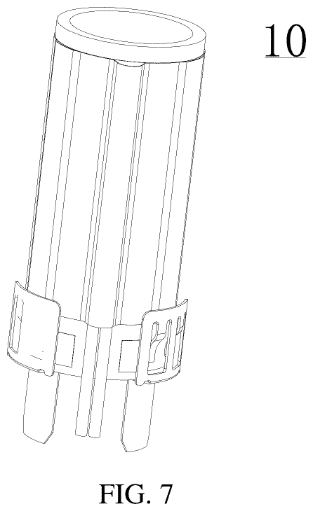

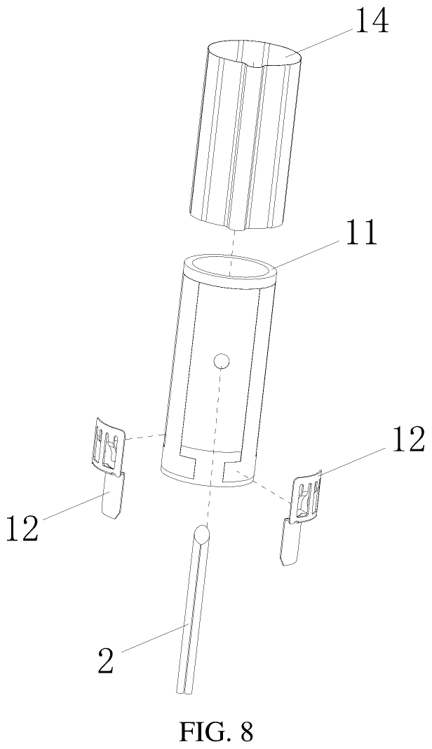

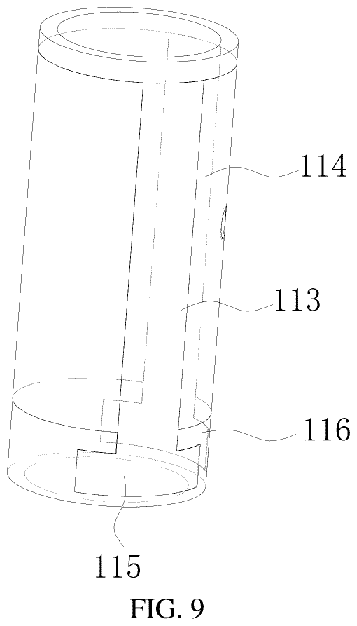

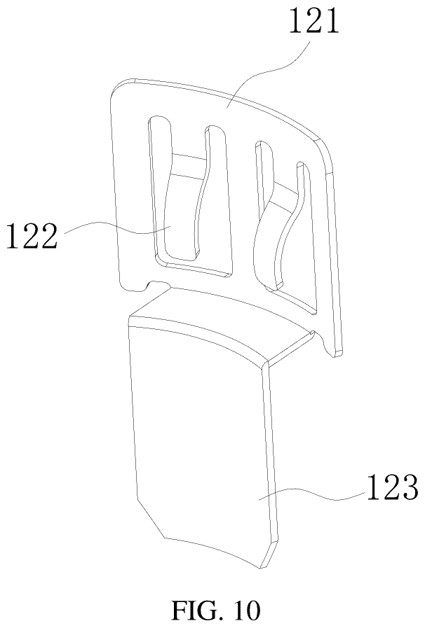

FIG. 7 to FIG. 10 each show another heating assembly according to another implementation of this application. Different from the examples in FIG. 3 to FIG. 6,
a conductive element further includes an electrode 115 and an electrode 116 that extend in a circumferential direction of the base 111. The electrode 115 is connected to the electrode 113, and the electrode 116 is connected to the electrode 114. Actually, the electrode 115 and the electrode 113 may be integrally formed, and the electrode 116 and the electrode 114 may be integrally formed. The electrode 115 and the electrode 116 are spaced apart from the infrared electric heating coating 112. For example, the portion B2 on the outer surface of the base 111 may be wider, and the electrode 115 and the electrode 116 may be both arranged on the portion B2 on the outer surface of the base 111, that is, the electrode 115 and the electrode 116 are arranged at the same end of the base 111. Certainly, the electrode 115 and the electrode 116 may alternatively be arranged on the portion B1 on the outer surface of the base 111, or the electrode 115 and the electrode 116 are arranged at different ends of the base 111.

In examples of FIG. 7 to FIG. 10, the electrode connection member 12 includes a contact portion and an extension 123. The contact portion includes a body 121 and one or more cantilevers 122 hollowed out on the body 121, and the plurality of cantilevers 122 are distributed in a manner of spacing apart in the circumferential direction of the base 111. When abutting against the electrode 115 or the electrode 116, the cantilever 122 can generate an elastic force to achieve an electrical connection with the electrode 115 or the electrode 116. The extension 123 extends from the body 121 to a position away from the base 111.

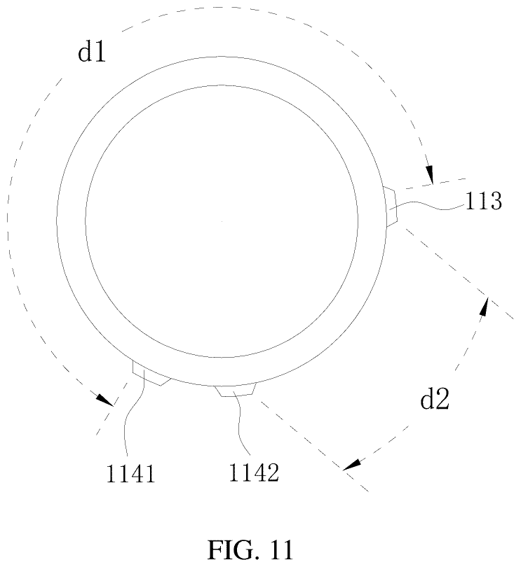

FIG. 11 shows a heater according to another implementation of this application. Different from the examples in FIG. 3 to FIG. 6,
an electrode 114 includes an electrode 1141 and an electrode 1142. There is a first circumferential distance d1 between the electrode 113 and the electrode 1141 in a first circumferential direction of the base 111, such as a counterclockwise direction in FIG. 11. There is a second circumferential distance d2 between the electrode 113 and the electrode 1142 in a direction opposite to the first circumferential direction, such as a clockwise direction in FIG. 11. The first circumferential distance d1 is different from the second circumferential distance d2.

In this example, the infrared electric heating coating 112 includes a first infrared electric heating coating between the electrode 113 and the electrode 1141, and a second infrared electric heating coating between the electrode 113 and the electrode 1142.

Similar to the above, the resistance of the second infrared electric heating coating is less than the resistance of the first infrared electric heating coating, the heating power of the second infrared electric heating coating is greater than the heating power of the first infrared electric heating coating, and the heating speed of the second infrared electric heating coating is greater than the heating speed of the first infrared electric heating coating.

It should be noted that, in FIG. 11, three electrodes are taken as an example, and in another example, there may alternatively be four or more electrodes, which can also be implemented.

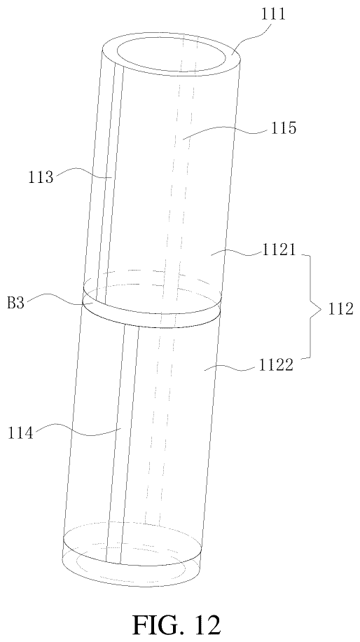

FIG. 12 shows a heater according to another implementation of this application. Different from the examples in FIG. 3 to FIG. 6,

A portion B3 on the outer surface of the base 111 divides the infrared electric heating coating 112 into two independently controllable heating regions, namely, an infrared electric heating coating 1121 and an infrared electric heating coating 1122. An axial extension length of the portion B3 may be as small as possible, for example, 0.4 mm to 1 mm, preferably 0.4 mm to 0.8 mm, and further preferably 0.5 mm.

The electrode further includes an electrode 115 spaced apart on the base 111, that is, the electrode 113, the electrode 114 and the electrode 115 are all spaced apart from each other. The electrode 115 remains in contact with both the infrared electric heating coating 1121 and the infrared electric heating coating 1122 to form an electrical connection, the electrode 113 remains in contact with the infrared electric heating coating 1121 to form an electrical connection, and the electrode 114 remains in contact with the infrared electric heating coating 1122 to form an electrical connection.

In this way, by controlling electrification of the electrode 113, the electrode 114 and the electrode 115, the aerosol-forming substrate can be heated segmentally. For example, the infrared electric heating coating 1121 is first started for heating (the electrode 113 and the electrode 115 are controlled to be electrified), and then the infrared electric heating coating 1122 is started for heating (the electrode 114 and the electrode 115 are controlled to be electrified), or the infrared electric heating coating 1121 is first started for heating (the electrode 113 and the electrode 115 are controlled to be electrified), and then the infrared electric heating coating 1121 and the infrared electric heating coating 1122 are started for heating together (the electrode 113, the electrode 114 and the electrode 115 are controlled to be electrified together).

Similar to the above, the electrode 113 and the electrode 115 divide the infrared electric heating coating 1121 into two infrared electric heating coatings in the circumferential direction of the base 111. Resistance of one of the two infrared electric heating coatings obtained by separation is less than resistance of the other infrared electric heating coating. After the electrode 113 and the electrode 115 conduct electricity, heating power of one of the infrared electric heating coatings is greater than heating power of the other infrared electric heating coating. Therefore, a heating speed of one of the infrared electric heating coatings is greater than a heating speed of the other infrared electric heating coating.

It should be noted that, the specification of this application and the accompanying drawings thereof illustrate preferred embodiments of this application. However, this application may be implemented in various different forms, and is not limited to the embodiments described in this specification. These embodiments are not intended to be an additional limitation on the content of this application, and are provided for the purpose of providing a more thorough and comprehensive understanding of the content disclosed in this application. Moreover, the foregoing technical features are further combined to form various embodiments not listed above, and all such embodiments shall be construed as falling within the scope of the specification of this application. Further, a person of ordinary skill in the art may make improvements or modifications according to the foregoing description, and all the improvements and modifications shall fall within the protection scope of the appended claims of this application.

1. A heating assembly, comprising:
a base;
electric heating film layers, which are arranged on a surface of the base and comprise a first electric heating film layer and a second electric heating film layer that are distributed in a circumferential direction of the base; and
a conductive element for feeding electric power to the first electric heating film layer and the second electric heating film layer,
wherein resistance of the first electric heating film layer is different from resistance of the second electric heating film layer, or heating power of the first electric heating film layer is different from heating power of the second electric heating film layer.

2. The heating assembly according to claim 1, wherein the tubular base has an inner diameter ranging from 6 mm to 15 mm, and/or the tubular base has an axial extension length ranging from 15 mm to 25 mm.

3. The heating assembly according to claim 1, wherein the electric heating film layer comprises an infrared electric heating coating for receiving electric power to generate heat and then generate infrared rays.

4. The heating assembly according to claim 1, wherein an axial extension length of the first electric heating film layer or the second electric heating film layer is less than or equal to an axial extension length of the base.

5. The heating assembly according to claim 1, wherein a circumferential extension length of the first electric heating film layer is different from a circumferential extension length of the second electric heating film layer.

6. The heating assembly according to claim 1, wherein the conductive element comprises a first electrode and a second electrode, such that a current is capable of flowing from the first electrode to the second electrode through the first electric heating film layer in a first circumferential direction of the base, and flowing from the first electrode to the second electrode through the second electric heating film layer in a second circumferential direction opposite to the first circumferential direction.

7. The heating assembly according to claim 6, wherein the first electrode and the second electrode both extend in an axial direction of the base.

8. The heating assembly according to claim 6, wherein a distance between the first electrode and the second electrode in the first circumferential direction is different from a distance between the first electrode and the second electrode in the second circumferential direction.

9. The heating assembly according to claim 8, wherein the distance between the first electrode and the second electrode in the first circumferential direction is 1.5 to 6 times the distance between the first electrode and the second electrode in the second circumferential direction.

10. The heating assembly according to claim 6, wherein the conductive element further comprises a third electrode; and
the current is capable of flowing from the first electrode to the second electrode through the first electric heating film layer in the first circumferential direction of the base, and flowing from the first electrode to the third electrode through the second electric heating film layer in the second circumferential direction opposite to the first circumferential direction.

11. The heating assembly according to claim 1, further comprising a temperature sensor, wherein the temperature sensor is used for detecting a temperature of one of the first electric heating film layer and the second electric heating film layer with lower resistance or higher heating power.

12. A heating assembly, comprising:
a base;
electric heating film layers, which are arranged on a surface of the base and comprise a first electric heating film layer and a second electric heating film layer that are distributed in a circumferential direction of the base; and
a conductive element for feeding electric power to the first electric heating film layer and the second electric heating film layer,
wherein an axial extension length of the first electric heating film layer is the same as an axial extension length of the second electric heating film layer, while a circumferential extension length of the first electric heating film layer is different from a circumferential extension length of the second electric heating film layer.

13. A heating assembly, comprising:
a base;
electric heating film layers, which are arranged on a surface of the base and comprise a first electric heating film layer and a second electric heating film layer that are distributed in a circumferential direction of the base; and
a conductive element for feeding electric power to the first electric heating film layer and the second electric heating film layer,
wherein a heating speed of the second electric heating film layer is greater than a heating speed of the first electric heating film layer.

14. (canceled)

15. An aerosol generating apparatus, comprising:
a housing assembly;
the heating assembly according to claim 1, wherein the heating assembly is arranged in the housing assembly;
a battery cell for providing electric power; and
a circuit configured to obtain temperature information of a second electric heating film layer, and control the battery cell to provide the electric power to a first electric heating film layer and the second electric heating film layer based on the temperature information of the second electric heating film layer.
